(19) United States
(12) Patent Application Publication
(10) Pub. No.: US 2025/0381809 A1
(43) Pub. Date: Dec. 18, 2025

(54) CARRIAGE COUPLING DEVICE

(71) Applicant: KABUSHIKI KAISHA TOYOTA JIDOSHOKKI, Kariya-shi (JP)

(72) Inventor: Masaru SHAMOTO, Kariya-shi (JP)

(73) Assignee: KABUSHIKI KAISHA TOYOTA JIDOSHOKKI, Kariya-shi (JP)

(21) Appl. No.: 19/233,113

(22) Filed: Jun. 10, 2025

(30) Foreign Application Priority Data
Jun. 14, 2024 (JP) 2024-096573

(51) Int. Cl. B60D 1/02; B60D 1/24

(52) U.S. Cl. CPC B60D 1/025; B60D 1/246

(57) ABSTRACT

A carriage coupling device couples a carriage to a towing vehicle. The carriage coupling device includes a coupling pin, a holder, a driver, and a stopper. The coupling pin is configured to drop along a guide toward an insertion position into which a connector of the carriage is inserted. The holder holds the coupling pin in a vertically movable manner. The driver automatically switches between a holding state and a non-holding state of the coupling pin by the holder. The stopper is biased to advance to the insertion position, supports the coupling pin above the insertion position in an advanced state to the insertion position, and allows the coupling pin to drop to the insertion position when retracting from the insertion position.

### CROSS-REFERENCE TO RELATED APPLICATION

This application claims priority to Japanese Patent Application No. 2024-096573 filed on Jun. 14, 2024, the entire disclosure of which is incorporated herein by reference.

### BACKGROUND ART

The present disclosure relates to a carriage coupling device.

In a technique related to a carriage coupling device for coupling a carriage to a towing vehicle, for example, there is a coupling device described in Japanese Utility Model Application Publication No. 63-54501. The conventional coupling device is a device provided at a rear portion of a towing vehicle. The coupling device includes a pair of flange portions that are vertically away from each other, a stopper having a U-shaped cross section and rotatably supported between the flange portions, and a coupling pin that is insertable through holes opened to face each other in the vertical direction in the pair of flange portions. In the coupling device of Japanese Utility Model Application Publication No. 63-54501, when a carriage side connection unit is pushed into the stopper between the flange portions, the stopper is released and the coupling pin drops. As a result, the coupling pin is inserted through the connection unit, and the towing vehicle and the carriage are coupled.

In the coupling device of Japanese Utility Model Application Publication No. 63-54501, it is necessary for an operator to get off the towing vehicle and push the carriage side connection unit into the stopper of the coupling device at the rear of the vehicle every time the carriage is coupled. Therefore, for example, there is a traction device described in Japanese Patent Application Publication No. 2022-184703 in a technique of automating coupling of a carriage.

This conventional traction device includes an engagement pin having an inner hole opened to one end side in a longitudinal direction, a lever portion integrated with the engagement pin so as to extend in a direction orthogonal to the longitudinal direction, a guide member having a support portion that supports the engagement pin so as to be able to guide movement of the engagement pin in the longitudinal direction and an opening through which the lever portion is insertable and that extends in the longitudinal direction, a spring disposed in the inner hole so as to be able to bias the engagement pin toward the other end side in the longitudinal direction, an eccentric cam having a cam follower contacting the lever portion, and a motor having a rotating shaft connected to the eccentric cam.

When the carriage is automatically coupled to the towing vehicle as in the traction device of Japanese Patent Application Publication No. 2022-184703 described above, it is necessary to accurately align the towing vehicle with the carriage so that the position of a carriage side connection unit coincides with the position of a coupling device side coupling pin. Therefore, for example, it is necessary to take another measure such as installing a guide on a vehicle side or a ground side so that the towing vehicle does not deviate in the traveling direction.

The present disclosure has been made to solve the above problems, and is directed to providing a carriage coupling device capable of automatically coupling a carriage to a towing vehicle without accurately aligning the towing vehicle and the carriage.

### SUMMARY

In accordance with an aspect of the present disclosure, there is provided a carriage coupling device that couples a carriage to a towing vehicle. The carriage coupling device includes a coupling pin, a holder, a driver, and a stopper. The coupling pin is configured to drop along a guide toward an insertion position into which a connector of the carriage is inserted. The holder holds the coupling pin in a vertically movable manner. The driver automatically switches between a holding state and a non-holding state of the coupling pin by the holder. The stopper is biased to advance to the insertion position, supports the coupling pin above the insertion position in an advanced state to the insertion position, and allows the coupling pin to drop to the insertion position when retracting from the insertion position.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a diagram illustrating an example of a travel route in a transport system using a towing vehicle and a carriage;

FIG. 2 is a block diagram illustrating a configuration of the towing vehicle to which a carriage coupling device according to the present embodiment is applied;

FIG. 3 is a perspective view illustrating a configuration of the carriage coupling device according to the present embodiment;

FIG. 4 is a side view illustrating a movement operation of the carriage coupling device;

FIG. 5 is a side view illustrating a coupling preparation operation of the carriage coupling device;

FIG. 6 is a side view illustrating a coupling operation of the carriage coupling device;

FIG. 7 is a side view illustrating a subsequent operation of FIG. 6;

FIG. 8 is a side view illustrating a coupling release operation of the carriage coupling device;

FIG. 9A is a schematic side view illustrating a coupling preparation state in a carriage coupling device according to a modification, and FIG. 9B is a schematic side view illustrating the coupling release operation; and

FIG. 10A is a schematic side view illustrating a coupling preparation state in a carriage coupling device according to another modification, and FIG. 10B is a schematic side view illustrating the coupling release operation.

### DETAILED DESCRIPTION OF THE EMBODIMENTS

Hereinafter, a preferred embodiment of a carriage coupling device according to an aspect of the present disclosure will be described in detail with reference to the drawings.

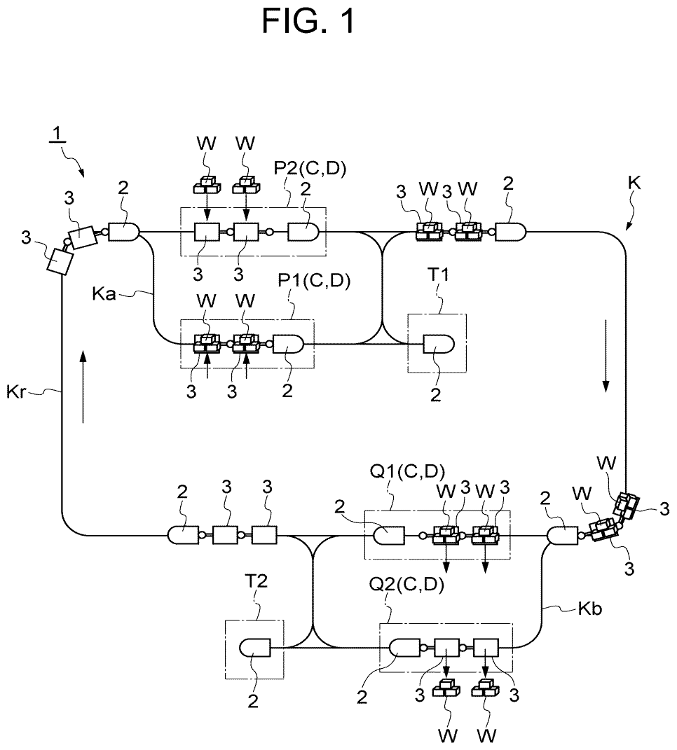

FIG. 1 is a diagram illustrating an example of a travel route in a transport system using a towing vehicle and a carriage. A transport system 1 illustrated in FIG. 1 is a system used for transporting a cargo W in, for example, a large warehouse such as an airport or a factory, and includes a plurality of towing vehicles 2 and a plurality of carriages 3. The towing vehicle 2 automatically travels on a preset travel route K, and couples one or a plurality of carriages 3 as necessary to transport the cargo W. In the example of FIG. 1, a first turn and a second turn to be described later are alternately performed in the transport system 1, and the transport of the cargo W by the towing vehicle 2 and the carriage 3 is continuously performed.

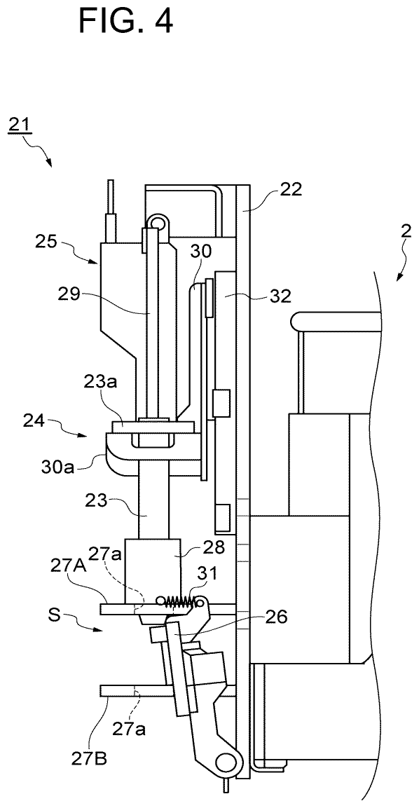

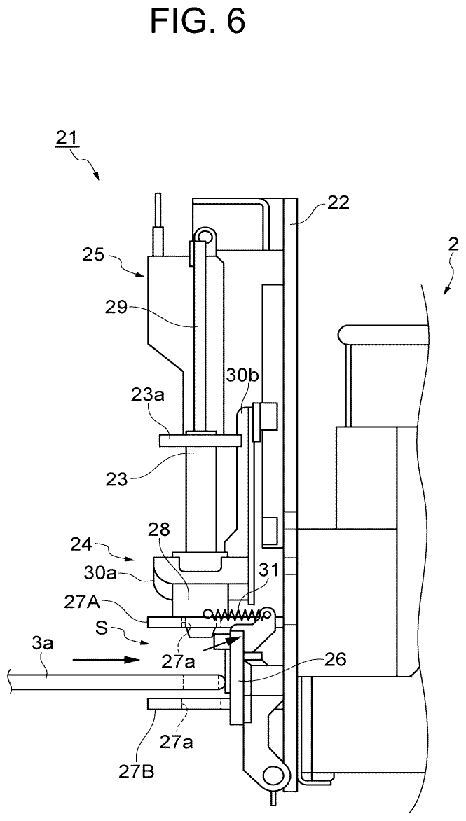

A carriage coupling device 21 to be described later is mounted on the towing vehicle 2. The carriage 3 includes a connector 3a (see FIG. 6 and the like) connected to the carriage coupling device 21. The connector 3a is constituted by, for example, an annular protrusion portion protruding forward from a front portion of the carriage 3. The carriage 3 is coupled to the towing vehicle 2 by an engagement of a coupling pin 23 (see FIG. 4 and the like) of the carriage coupling device 21 with the annular protrusion portion. In addition, the coupling of the carriage 3 to the towing vehicle 2 is released by releasing the engagement of the coupling pin 23 of the carriage coupling device 21 with the annular protrusion portion.

The travel route K is a lap route including a loading position P where the cargo W is loaded, an unloading position Q where the cargo W is unloaded, a coupling position C where the carriage 3 is coupled to the towing vehicle 2, and a coupling release position D where the carriage 3 is disconnected from the towing vehicle 2. The travel route K includes an entire lap route Kr connecting the loading position P and the unloading position Q, a branch route Ka set around the loading position P, and a branch route Kb set around the unloading position Q.

In the branch route Ka, two loading positions P1 and P2 and a standby position T1 of the towing vehicle 2 are set. In the first turn of the transport system 1, the loading position P1 is the coupling position C, and the loading position P2 is the coupling release position D. In the second turn of the transport system 1, the loading position P1 is the coupling release position D, and the loading position P2 is the coupling position C. In the branch route Kb, two unloading positions Q1 and Q2 and a standby position T2 of the towing vehicle 2 are set. In the first turn of the transport system 1, the unloading position Q1 is the coupling release position D, and the unloading position Q2 is the coupling position C. In the second turn of the transport system 1, the unloading position Q1 is the coupling position C, and the unloading position Q2 is the coupling release position D.

In the first turn of the transport system 1, the towing vehicle 2 moves backward from the standby position T1 connected to the branch route Ka to the loading position P1, and the carriage 3 on which the cargo W is placed is coupled at the loading position P1. The towing vehicle 2 tows the carriage 3 on which the cargo W is placed and travels toward the unloading position Q1. At the unloading position Q1, the cargo W is unloaded from the carriage 3, and then the carriage 3 is disconnected from the towing vehicle 2. After the carriage 3 is disconnected, the towing vehicle 2 travels to the standby position T2 connected to the branch route Kb and stands by at the standby position T2.

Next, the towing vehicle 2 moves backward from the standby position T2 to the unloading position Q2, and the carriage 3 on which the cargo W is not placed is coupled at the unloading position Q2. The towing vehicle 2 tows the carriage 3 on which the cargo W is not placed and travels toward the loading position P2. At the loading position P2, the carriage 3 is disconnected from the towing vehicle 2, and then the cargo W is loaded on the carriage. After the carriage 3 is disconnected, the towing vehicle 2 travels to the standby position T1 connected to the branch route Ka and stands by at the standby position T1.

In the second turn of the transport system 1, the towing vehicle 2 moves backward from the standby position T1 to the loading position P2, and the carriage 3 on which the cargo W is placed is coupled at the loading position P2. The towing vehicle 2 tows the carriage 3 on which the cargo W is placed and travels toward the unloading position Q2. At the unloading position Q2, the cargo W is unloaded from the carriage 3, and then the carriage 3 is disconnected from the towing vehicle 2. After the carriage 3 is disconnected, the towing vehicle 2 travels to the standby position T2 connected to the branch route Kb and stands by at the standby position T2.

Next, the towing vehicle 2 moves backward from the standby position T2 to the unloading position Q1, and the carriage 3 on which the cargo W is not placed is coupled at the unloading position Q1. The towing vehicle 2 tows the carriage 3 on which the cargo W is not placed and travels toward the loading position P1. At the loading position P1, the carriage 3 is disconnected from the towing vehicle 2, and then the cargo W is loaded on the carriage. After the carriage 3 is disconnected, the towing vehicle 2 travels to the standby position T1 connected to the branch route Ka and stands by at the standby position T1.

Next, a configuration of the towing vehicle 2 will be described.

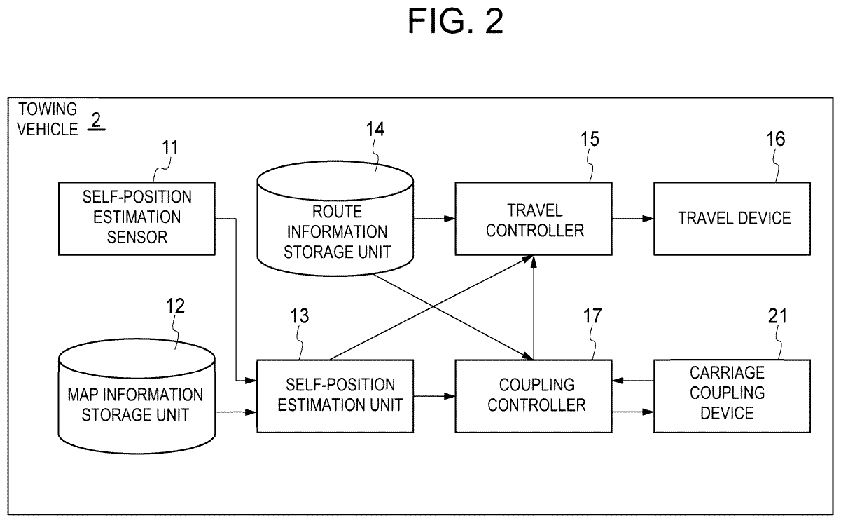

FIG. 2 is a block diagram illustrating a configuration of a towing vehicle to which the carriage coupling device according to the present embodiment is applied. As illustrated in FIG. 2, the towing vehicle 2 includes a self-position estimation sensor 11, a map information storage unit 12, a self-position estimation unit 13, a route information storage unit 14, a travel controller 15, a travel device 16, a coupling controller (controller) 17, and the carriage coupling device 21. Among these components, the map information storage unit 12, the self-position estimation unit 13, the route information storage unit 14, the travel controller 15, and the coupling controller 17 are physically configured by a computer system including a storage device such as a RAM and a ROM, a processor such as a CPU, a communication interface, and the like. In FIG. 2, for convenience of description, the coupling controller 17 and the carriage coupling device 21 are illustrated as separate blocks, but the coupling controller 17 is a component of the carriage coupling device 21.

The self-position estimation sensor 11 is a sensor used to estimate a self-position of the towing vehicle 2. The self-position estimation sensor 11 detects an object existing around the towing vehicle 2. As the self-position estimation sensor 11, for example, a laser sensor such as light detection and ranging (LiDAR) or a laser range finder is used. The self-position estimation sensor 11 irradiates the periphery of the towing vehicle 2 with laser light and receives reflected light of the laser light, thereby detecting a distance from the self-position estimation sensor 11 to an object present around the towing vehicle 2. The self-position estimation sensor 11 outputs detection result information indicating a detection result to the self-position estimation unit 13.

The map information storage unit 12 stores map information about a place where the towing vehicle 2 travels, that is, a place where the travel route K is set. The map information includes, for example, information indicating a building, a pillar, a wall, other obstacles, and the like. The map information may be input in advance by the user of the towing vehicle 2 or may be received from a server or the like via a network.

The route information storage unit 14 is a unit that stores route information related to the travel route K of the towing vehicle 2. The route information includes, in addition to the information indicating the travel route K, information about the loading position P where cargo is loaded and the unloading position Q where cargo is unloaded. That is, the route information includes the coupling position C of the carriage 3 with respect to the towing vehicle 2 and the coupling release position D of the carriage 3 with respect to the towing vehicle 2. As in the map information, the route information may be input in advance by the user of the towing vehicle 2 or may be received from a server or the like via a network.

The self-position estimation unit 13 is a unit that acquires position information about the towing vehicle 2. The self-position estimation unit 13 estimates the self-position of the towing vehicle 2 based on the detection result information from the self-position estimation sensor 11 and the map information stored in the map information storage unit 12. Specifically, the self-position estimation unit 13 estimates the self-position of the towing vehicle 2 by matching the detection result information by the self-position estimation sensor 11 and the map information using, for example, a simultaneous localization and mapping (SLAM) method. The SLAM is a self-position estimation technology that performs self-position estimation using sensor data and map data. The self-position estimation unit 13 outputs estimation result information (position information) indicating an estimation result of the self-position of the towing vehicle 2 to the travel controller 15 and the coupling controller 17.

The travel controller 15 is a unit that controls the operation of the travel device 16. The travel controller 15 refers to the route information stored in the route information storage unit 14 based on the estimation result information output from the self-position estimation unit 13, and controls the travel device 16 so that the towing vehicle 2 travels along the travel route K. When it is detected that an obstacle exists in the vicinity of the towing vehicle 2 by an obstacle detection sensor (not illustrated) or the like, the travel controller 15 controls the travel device 16 so that the towing vehicle 2 decelerates or stops.

The travel device 16 is a device related to traveling of the towing vehicle 2. For example, the device includes a vehicle body, a pair of front wheels disposed at a front portion of the vehicle body, and a pair of rear wheels disposed at a rear portion of the vehicle body. In the travel device 16, for example, the front wheel is a driving wheel, and the rear wheel is a steering wheel. The travel device 16 drives the front wheel and the rear wheel based on the control from the travel controller 15, and causes the towing vehicle 2 to travel along the travel route K.

The coupling controller 17 is a unit that controls the operation of the carriage coupling device 21. The coupling controller 17 controls the coupling operation and the coupling release operation of the connector 3a of the carriage 3. Specifically, the coupling controller 17 refers to the route information stored in the route information storage unit 14 based on the estimation result information output from the self-position estimation unit 13. When determining that the towing vehicle 2 moves from the coupling release position D to the coupling position C of the carriage 3, the coupling controller 17 causes the carriage coupling device 21 to perform the movement operation. The coupling controller 17 causes the carriage coupling device 21 to perform the coupling preparation operation and the coupling operation when determining that the towing vehicle 2 is located at the coupling position C of the carriage 3, and causes the carriage coupling device 21 to perform the coupling release operation when determining that the towing vehicle 2 is located at the coupling release position D of the carriage 3. Details of the movement operation, the coupling preparation operation, the coupling operation, and the coupling release operation will be described later.

Next, a configuration of the carriage coupling device 21 will be described.

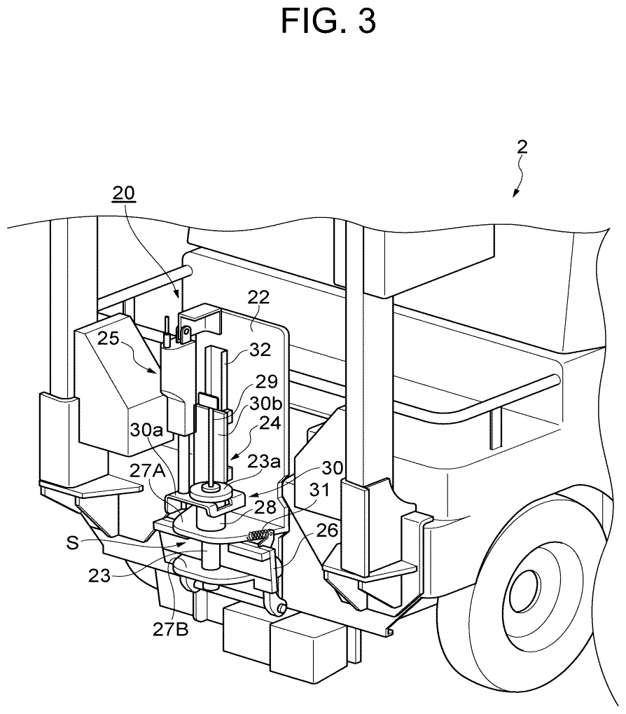

FIG. 3 is a perspective view illustrating a configuration of the carriage coupling device according to the present embodiment. As illustrated in FIG. 3, the carriage coupling device 21 is provided at the rear portion of the towing vehicle 2. The carriage coupling device 21 includes a base plate 22, the coupling pin 23, a holder 24, a driver 25, and a stopper 26.

The base plate 22 is a plate serving as a base of the carriage coupling device 21. The base plate 22 has, for example, a rectangular shape, and is disposed at a central part in the width direction of the rear portion of the towing vehicle 2 so that a main surface thereof is directed to the rear side of the towing vehicle 2. A pair of plates having an upper plate 27A and a lower plate 27B is provided on a lower part of the base plate 22. The plates 27A and 27B have, for example, an isosceles trapezoidal shape to have a bottom side at the base plate 22 when viewed in the height direction of the towing vehicle 2.

The plates 27A and 27B are disposed in parallel to each other in a state of being away from each other at a predetermined interval in the height direction of the towing vehicle 2, and protrude from the base plate 22 to the rear of the towing vehicle 2. The space between the plates 27A and 27B is an insertion position S into which the connector 3a of the carriage 3 to be coupled is inserted. The plates 27A and 27B have respective holes 27a coaxially (see FIG. 4 and the like) through which the coupling pin 23 is insertable. The upper plate 27A is provided with a tubular guide 28 protruding upward around the hole 27a. A guide member (not illustrated) that guides the connector 3a of the carriage 3 toward the insertion position S may be attached to the lower plate 27B.

The coupling pin 23 is a pin that engages with the connector 3a when the carriage 3 is coupled. The coupling pin 23 is configured to drop along the guide 28 toward the insertion position S into which the connector 3a of the carriage 3 is inserted. Specifically, the coupling pin 23 has a tubular shape with a diameter which is insertable through the holes 27a of the plates 27A and 27B and the guide 28. For example, a circular flange 23a is provided at an upper end portion of the coupling pin 23. The drop of the coupling pin 23 is restricted at a position where the flange 23a contacts the upper end of the guide 28. When the coupling pin 23 drops and the flange 23a contacts the upper end of the guide 28, the coupling pin 23 is inserted through the hole 27a of each of the plates 27A and 27B and advanced to the insertion position S between the plates 27A and 27B.

In the present embodiment, the coupling pin 23 is provided with a handle portion 29 protruding upward above the flange 23a. The handle portion 29 includes, for example, a rod-shaped portion having a diameter smaller than that of the main body of the coupling pin 23 and a plate-shaped gripping portion provided at the distal end of the rod-shaped portion. By providing the handle portion 29, it is possible to easily correct the position of the coupling pin 23 by manually pulling up the handle portion 29 in a case where the drop position of the coupling pin 23 is shifted.

The holder 24 is a unit that holds the coupling pin 23 in a vertically movable manner. In the present embodiment, the holder 24 includes a linear motion table 30 that is moved up and down by the driver 25. The linear motion table 30 has a table portion 30a engaged with the coupling pin 23 and an engagement portion 30b engaged with a linear motion guide 32. The table portion 30a has a frame shape through which the coupling pin 23 and the guide 28 are insertable and is mechanically connected to the driver 25. While the coupling pin 23 is inserted through the table portion 30a, the table portion contacts the lower part of the flange 23a of the coupling pin 23. The engagement portion 30b protrudes upward from an edge portion of the table portion 30a on the towing vehicle 2 side, and is engaged with the linear motion guide 32 provided on the base plate 22.

The driver 25 is a unit that automatically switches between the holding state and the non-holding state of the coupling pin 23 by the holder 24. The driver 25 includes an actuator such as an electric cylinder. In the present embodiment, the driver 25 smoothly moves the linear motion table 30 up and down in the vertical direction between the upper end position and the lower end position along the linear motion guide 32. In a case where the coupling pin 23 is located above (the position retracted from the insertion position S) and the table portion 30a of the holder 24 is located at the upper end position and is in contact with the lower part of the flange 23a, the coupling pin 23 is in the holding state and the drop of the coupling pin 23 is restricted.

In a case where the coupling pin 23 is located above (the position retracted from the insertion position S) and the table portion 30a of the holder 24 is located at the lower end position and is not in contact with the lower part of the flange 23a, the coupling pin 23 is in the non-holding state, and the coupling pin 23 is allowed to drop. When the linear motion table 30 rises after the coupling pin 23 drops, the linear motion table 30 and the coupling pin 23 rise together due to the engagement of the table portion 30a with the flange 23a.

The stopper 26 is a unit that restricts the drop of the coupling pin 23. In the present embodiment, the lower end portion of the stopper 26 is rotatably and pivotally supported at the lower end portion of the base plate 22, and the upper end portion of the stopper 26 is coupled to a spring 31 attached to the side face of the upper plate 27A. The stopper 26 is biased by a spring 31 so as to advance to the insertion position S. In the state of advancing to the insertion position S, the upper end portion of the stopper 26 supports the lower end portion of the coupling pin 23 before dropping above the insertion position S.

The stopper 26 is retracted from the insertion position S by being pushed in a direction opposite to the biasing direction by the spring 31 by the connector 3a of the carriage 3 that has entered the insertion position S. In the state retracted from the insertion position S, the support of the lower end portion of the coupling pin 23 by the upper end portion of the stopper 26 is released, and the coupling pin 23 is allowed to drop to the insertion position S.

Next, the operation of the carriage coupling device 21 will be described.

As described above, the carriage coupling device 21 performs each operation of the movement operation, the coupling preparation operation, the coupling operation, and the coupling release operation based on the control of the coupling controller 17. The movement operation is an operation applied to a period in which the towing vehicle 2 moves from the coupling release position D to the coupling position C of the carriage 3. In the transport system 1 illustrated in FIG. 1, the movement operation is basically applied when the towing vehicle 2 travels on the entire lap route Kr, branch route Kb, and branch route Kb without the carriage 3 coupled except when the towing vehicle 2 is stopped at the coupling position C and the coupling release position D.

In the movement operation, the coupling pin 23 supported by the stopper 26 is held in a holding state by the holder 24. In the movement operation, as shown in FIG. 4, the linear motion table 30 is at the upper end position, and the coupling pin 23 is held at the upper position at which the pin is retracted from the insertion position S. The stopper 26 is biased to advance to the insertion position S, and supports the lower end portion of the coupling pin 23 above the insertion position S in a state of advancing to the insertion position S.

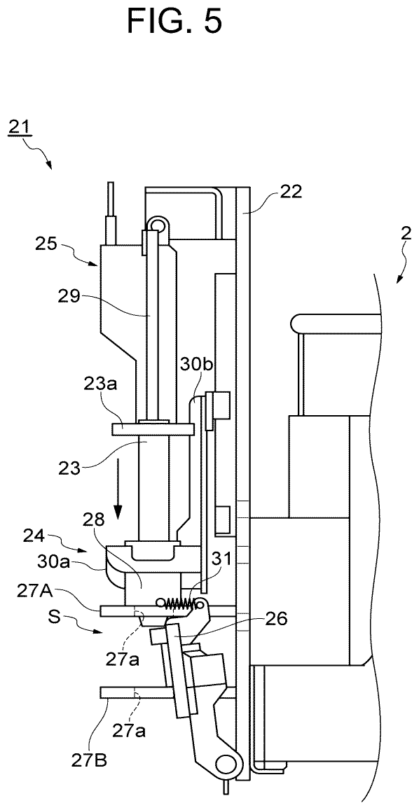

The coupling preparation operation and the coupling operation are operations applied when the towing vehicle 2 is located at the coupling position C of the carriage 3. In the coupling preparation operation, the coupling pin 23 supported by the stopper 26 is brought into a non-holding state by the holder 24. In the coupling preparation operation, as illustrated in FIG. 5, the driver 25 lowers the linear motion table 30 from the upper end position to the lower end position. As a result, the coupling pin 23 is brought into the non-holding state, and the coupling pin 23 is allowed to drop. However, in the coupling preparation operation, a state in which the stopper 26 has advanced to the insertion position S is maintained. Therefore, the lower end portion of the coupling pin 23 remains supported by the stopper 26, and the coupling pin 23 continues to be held at the upper position at which the pin is retracted from the insertion position S.

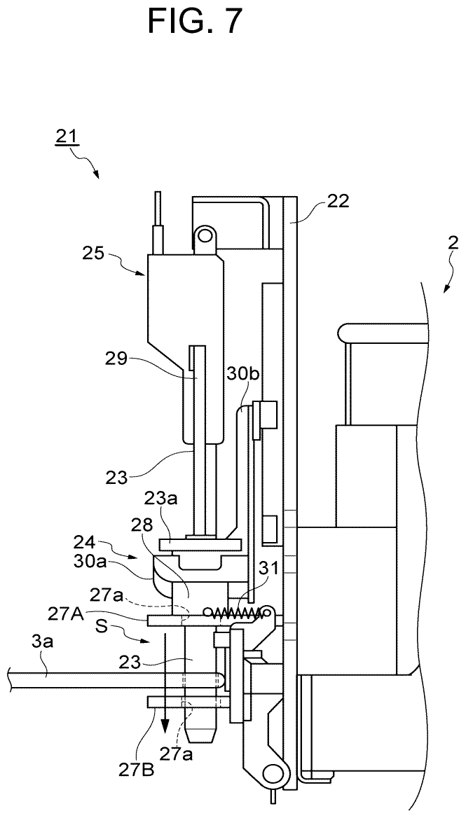

In the coupling operation, as illustrated in FIG. 6, when the connector 3a of the carriage 3 is inserted into the insertion position S, the stopper 26 pushed by the connector 3a is retracted from the insertion position S. When the stopper 26 retracts from the insertion position S, the coupling pin 23 drops into the insertion position S and engages with the connector 3a at the insertion position S as illustrated in FIG. 7. Accordingly, the carriage 3 is coupled to the towing vehicle 2.

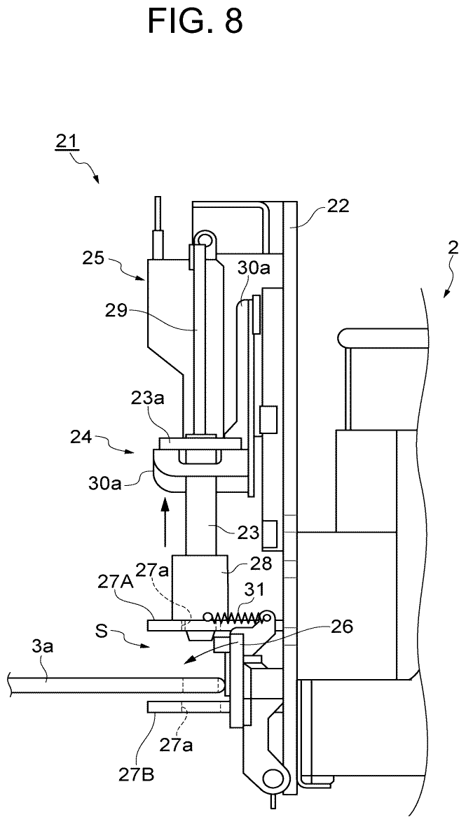

The coupling release operation is an operation applied when the towing vehicle 2 is located at the coupling release position D of the carriage 3. In the coupling release operation, as illustrated in FIG. 8, the linear motion table 30 rises from the lower end position to the upper end position by the driver 25. Accordingly, the coupling pin 23 rises to the upper position together with the linear motion table 30 and retracts from the insertion position S. When the coupling pin 23 retracts from the insertion position S, the engagement of the coupling pin 23 with the connector 3a is released, and the coupling of the towing vehicle 2 to the carriage 3 is released. After the coupling is released, when the connector 3a retracts from the insertion position S, the stopper 26 advances to the insertion position S by the biasing of the spring 31. As a result, the lower end portion of the coupling pin 23 at the upper position is held, and the operation shifts to the movement operation illustrated in FIG. 4.

As described above, in the carriage coupling device 21, when the connector 3a of the carriage 3 is inserted into the insertion position S, the stopper 26 pushed by the connector 3a is retracted from the insertion position S. When the stopper 26 retracts from the insertion position S, the coupling pin 23 drops into the insertion position S and engages with the connector 3a, so that the carriage 3 can be easily coupled to the towing vehicle 2 without accurately aligning the towing vehicle 2 and the carriage 3. In addition, in the carriage coupling device 21, the holding state and the non-holding state of the coupling pin 23 by the holder 24 can be automatically switched by the driver 25. As a result, it is not necessary for the operator to manually perform the coupling operation and the coupling release operation of the connector 3a of the carriage 3, and efficiency of work using the towing vehicle 2 and the carriage 3 is improved.

In the present embodiment, the carriage coupling device 21 includes the coupling controller 17 that controls the coupling operation and the coupling release operation of the connector 3a. When determining that the towing vehicle 2 is located at the coupling position C of the carriage 3 based on the position information about the towing vehicle 2, the coupling controller 17 controls the driver 25 so that the coupling pin 23 supported by the stopper 26 is brought into the non-holding state by the holder 24. According to such a configuration, when the towing vehicle 2 is located at the coupling position C of the carriage 3, the holding of the coupling pin 23 by the holder 24 is released, and the coupling preparation state in which the coupling pin 23 is supported only by the stopper 26 is obtained. Therefore, it is possible to quickly couple the carriage 3, and it is possible to further improve the efficiency of the work using the towing vehicle 2 and the carriage 3.

In the present embodiment, when determining that the towing vehicle 2 moves from the coupling release position D to the coupling position C of the carriage 3 based on the position information, the coupling controller 17 controls the driver 25 so that the coupling pin 23 supported by the stopper 26 is in the holding state by the holder 24. According to such a configuration, the holding of the coupling pin 23 by the holder 24 is maintained until the towing vehicle 2 reaches the coupling position C of the carriage 3. Therefore, it is possible to prevent a problem that the coupling pin 23 drops into the insertion position S due to a malfunction caused by vibration or the like during traveling of the towing vehicle 2.

In the present embodiment, the carriage coupling device 21 includes the pair of plates having the upper plate 27A and the lower plate 27B having the respective holes 27a through which the coupling pin 23 is insertable. The upper plate 27A of the plates 27A and 27B is provided with the guide 28 in a tubular shape so that the guide 28 protrudes around the hole 27a of the upper plate 27A, and the coupling pin 23 has the flange 23a that contacts the guide 28 when the coupling pin 23 drops into the insertion position S. As a result, the drop operation of the coupling pin 23 is stabilized by the holes 27a of the plates 27A and 27B, the tubular guide 28, and the flange 23a contacting the guide 28.

In the present embodiment, the holder 24 includes a linear motion table 30 that is moved up and down by the driver 25. Consequently, the holder 24 and the driver 25 can be constructed with a simple configuration.

The present disclosure is not limited to the above embodiments. For example, in the above embodiment, the holder 24 includes the linear motion table 30 that is moved up and down by the driver 25, but the configuration of the holder 24 can take other modes.

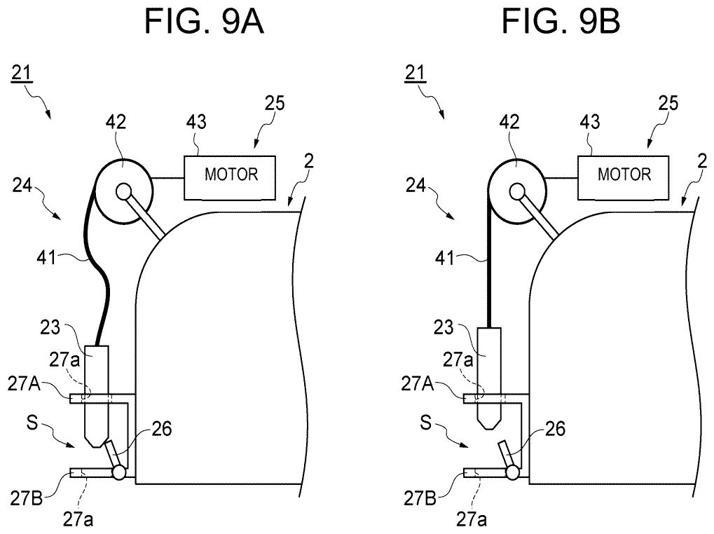

For example, as illustrated in FIGS. 9A and 9B, the holder 24 may include a wire 41 wound up and wound down by the driver 25. In the examples of FIGS. 9A and 9B, the coupling pin 23 is suspended in the vertical direction at the distal end of the wire 41. The proximal end of the wire 41 is engaged with a pulley 42 attached to the rear portion of the towing vehicle 2. The driver 25 includes, for example, a motor 43, and the motor 43 rotates the pulley 42, so that the wire 41 can be wound up and down.

In the coupling preparation operation, as illustrated in FIG. 9A, the wire 41 is wound down to bend the wire 41 between the pulley 42 and the coupling pin 23 at the upper position. As a result, the coupling pin 23 supported by the stopper 26 is brought into the non-holding state by the holder 24, and in the subsequent coupling operation, the connector 3a of the carriage 3 pushes the stopper 26, so that the coupling pin 23 drops into the insertion position S and engages with the connector 3a.

In the coupling release operation, as illustrated in FIG. 9B, by winding up the wire 41, the coupling pin 23 lifted by the wire 41 rises to the upper position and retracts from the insertion position S. As a result, the engagement of the coupling pin 23 with the connector 3a is released, and the coupling of the towing vehicle 2 to the carriage 3 is released.

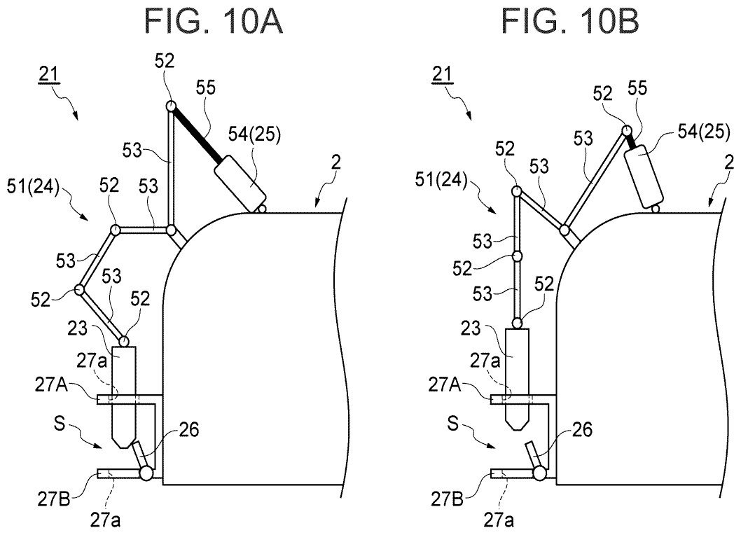

Furthermore, for example, as illustrated in FIGS. 10A and 10B, the holder 24 may include a linkage 51 in which a joint portion 52 is operated by the driver 25. In the example of FIGS. 10A and 10B, the linkage 51 includes a plurality of bar-shaped members 53 and a plurality of joint portions 52 rotatably connecting the bar-shaped members 53 to each other. Furthermore, the driver 25 includes, for example, an electric cylinder 54. The coupling pin 23 is suspended in the vertical direction at the distal end of the linkage 51. The proximal end of the linkage 51 is connected to the electric cylinder 54 attached to the rear portion of the towing vehicle 2, and the rotation state of the plurality of bar-shaped members 53 can be changed by expansion and contraction of the rod 55 of the electric cylinder 54.

In the coupling preparation operation, as illustrated in FIG. 10A, the rod 55 is extended to bend the plurality of bar-shaped members 53 between the electric cylinder 54 and the coupling pin 23 at the upper position. As a result, the coupling pin 23 supported by the stopper 26 is brought into the non-holding state by the holder 24, and in the subsequent coupling operation, the connector 3a of the carriage 3 pushes the stopper 26, so that the coupling pin 23 drops into the insertion position S and engages with the connector 3a.

In the coupling release operation, as illustrated in FIG. 10B, by contracting the rod 55, the coupling pin 23 lifted by the plurality of bar-shaped members 53 rises to the upper position and retracts from the insertion position S. As a result, the engagement of the coupling pin 23 with the connector 3a is released, and the coupling of the towing vehicle 2 to the carriage 3 is released.

Even in these configurations, the same function and effect as those of the above embodiment are obtained, and the carriage 3 can be automatically coupled to the towing vehicle 2 without accurately aligning the towing vehicle 2 and the carriage 3. In addition, the holder 24 and the driver 25 can be realized with a simple configuration.

What is claimed is:

1. A carriage coupling device that couples a carriage to a towing vehicle, the carriage coupling device comprising:
a coupling pin configured to drop along a guide toward an insertion position into which a connector of the carriage is inserted;
a holder that holds the coupling pin in a vertically movable manner;
a driver that automatically switches between a holding state and a non-holding state of the coupling pin by the holder; and
a stopper that is biased to advance to the insertion position, supports the coupling pin above the insertion position in an advanced state to the insertion position, and allows the coupling pin to drop to the insertion position when retracting from the insertion position.

2. The carriage coupling device according to claim 1, further comprising:
a controller that controls a coupling operation and a coupling release operation of the connector, wherein
when determining that the towing vehicle is located at a coupling position of the carriage based on position information about the towing vehicle, the controller controls the driver so that the coupling pin supported by the stopper is in a non-holding state by the holder.

3. The carriage coupling device according to claim 2, wherein
when determining that the towing vehicle moves from a coupling release position to the coupling position of the carriage based on the position information, the controller controls the driver so that the coupling pin supported by the stopper is in a holding state by the holder.

4. The carriage coupling device according to claim 1, further comprising:
a pair of plates having an upper plate and a lower plate having respective holes through which the coupling pin is insertable, wherein
the upper plate of the pair of plates is provided with the guide in a tubular shape so that the guide protrudes around the hole of the upper plate, and
the coupling pin has a flange that contacts the guide when the coupling pin drops to the insertion position.

5. The carriage coupling device according to claim 1, wherein
the holder includes a linear motion table that moves up and down by the driver.

6. The carriage coupling device according to claim 1, wherein
the holder includes a wire wound up and wound down by the driver.

7. The carriage coupling device according to claim 1, wherein
the holder includes a linkage in which a joint portion is operated by the driver.
